(19) United States
(12) Patent Application Publication
(10) Pub. No.: US 2020/0050089 A1
(43) Pub. Date: Feb. 13, 2020

(54) Multi-Image Electronic Projector

(71) Applicant: Patricia Parks, Summerville, SC (US)

(72) Inventor: Patricia Parks, Summerville, SC (US)

(21) Appl. No.: 16/524,908

(22) Filed: Jul. 29, 2019

Related U.S. Application Data
(60) Provisional application No. 62/717,900, filed on Aug. 12, 2018.

(51) Int. Cl. G03B 21/14; G03B 21/20

(52) U.S. Cl. CPC G03B 21/145; G03B 21/208

(57) ABSTRACT

According to some embodiments, a multi-image electronic projector configured for projecting multiple images may be disclosed. Further, the multi-image electronic projector may include a main body, a ring for suspending the multi-image electronic projector from a suspension mechanism, a plurality of projection lenses for projecting at least one media file, at least one input mechanism to receive user input corresponding to at least one of an operation mode, a communication device for receiving the at least one media file from a user device, a processing device for projecting the at least one media file through the plurality of projection lenses and a power source for being electrically coupled to each of the communication device, the plurality of projection lenses, the input mechanism, and the processing device.

### RELATED APPLICATION(S)

Under provisions of 35 U.S.C. § 119, the Applicant(s) claim the benefit of U.S. provisional application No. 62/717,900 filed on Aug. 12, 2018, which is incorporated herein by reference.

### FIELD OF THE INVENTION

The disclosure relates generally to image projectors, and in particular to a multi-image electronic projector.

### BACKGROUND OF THE INVENTION

Many families and organizations may have accumulated a large collections of photographs of their members, individually and/or in groups of various sizes. Projecting these images on the walls or similar surfaces at parties, banquets, and other gatherings may be often an important feature of these events.

Further, a device which may be used to project multiple images simultaneously on multiple surfaces does not exist.

Therefore, there is a need for an improved multi-image electronic projector that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a multi-image electronic projector configured for projecting multiple images may be disclosed. Further, the multi-image electronic projector may include a main body, a ring, a plurality of projection lenses, at least one input mechanism, a communication device, a processing device and a power source. Further, the main body may include a generally elongated shape. Further, the main body may include a generally cylindrical first portion, and a generally hemispherical second portion extending downwards from a bottom end of the first portion. Further, the ring may be extending from a top surface of the first portion. Further, the ring may be configured to suspend the multi-image electronic projector from a suspension mechanism. Further, the plurality of projection lenses may be disposed on each of the first portion and the second portion configured for projecting at least one media file. Further, the at least one input mechanism may be configured to receive user input corresponding to at least one of an operation mode and an operation state of the multi-image electronic projector. Further, the communication device may be configured for receiving the at least one media file from a user device. Further, processing device communicatively connected to the communication device configured for projecting the at least one media file through the plurality of projection lenses. Further, the power source electrically coupled to each of the communication device, the plurality of projection lenses, the input mechanism, and the processing device.

Further, according to some embodiments, a multi-image electronic projector configured for projecting multiple images may be disclosed. Further, the multi-image electronic projector may include a main body, a ring, a plurality of projection lenses, a touch display, a communication device, a processing device, a power source, an audio output device and a ring shaped stand. Further, the main body may include a generally elongated shape. Further, the main body may include a generally cylindrical first portion, and a generally hemispherical second portion extending downwards from a bottom end of the first portion. Further, the ring may be extending from a top surface of the first portion. Further, the ring may be configured to suspend the multi-image electronic projector from a suspension mechanism. Further, the plurality of projection lenses disposed on each of the first portion and the second portion configured for projecting at least one media file. Further, the touch display may be configured for receiving user input through one or more touch gestures corresponding to at least one of an operation mode and an operation state of the multi-image electronic projector. Further, the communication device may be configured for receiving the at least one media file from a user device. Further, the processing device may be communicatively connected to the communication device configured for projecting the at least one media file through the plurality of projection lenses. Further, the power source electrically coupled to each of the communication device, the plurality of projection lenses, the input mechanism, and the processing device. Further, the audio output device may be disposed on the top surface of the first portion configured to provide audio-based output included in the at least one media file. Further, the ring shaped stand may include a plurality of legs configured to support a circular supporting structure. Further, the circular supporting structure may be configured for supporting the main body.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front perspective view of a multi-image projector, in accordance with some embodiments.

FIG. 2 is a front view of a multi-image projector, in accordance with some embodiments.

FIG. 3 is a top view of a multi-image projector, in accordance with some embodiments.

FIG. 4 is a bottom perspective view of a multi-image projector, in accordance with some embodiments.

FIG. 5 is a side view of a ring shaped stand, in accordance with some embodiments.

FIG. 6 is a rear perspective view of a multi-image projector, in accordance with some embodiments.

FIG. 7 is a bottom view of a multi-image projector, in accordance with some embodiments.

FIG. 8 is a top perspective view of a ring shaped stand, in accordance with some embodiments.

FIG. 9 is a front perspective view of a multi-image projector mounted on a ring shaped stand, in accordance with some embodiments

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a sanitizing device, embodiments of the present disclosure are not limited to use only in this context.

A multi-image electronic projector 100 configured for projecting multiple images may be disclosed. Further, the multi-image electronic projector 100 may include a main body 102, a ring 106, a plurality of projection lenses 104, at least one input mechanism 108, a communication device, a processing device, a power source.

Further, the main body 102 may include a generally elongated shape. Further, the main body 102 may include a generally cylindrical first portion, and a generally hemispherical second portion extending downwards from a bottom end of the first portion.

Further, the ring 106 may be extending from a top surface of the first portion. Further, the ring 106 may be configured to suspend the multi-image electronic projector 100 from a suspension mechanism.

Further, the plurality of projection lenses 104 may be disposed on each of the first portion and the second portion configured for projecting at least one media file.

Further, the at least one input mechanism 108 may be configured to receive user input corresponding to at least one of an operation mode and an operation state of the multi-image electronic projector 100.

Further, the communication device may be configured for receiving the at least one media file from a user device.

Further, the processing device may be communicatively connected to the communication device configured for projecting the at least one media file through the plurality of projection lenses 104

Further, the power source electrically coupled to each of the communication device, the plurality of projection lenses 104, the input mechanism 108, and the processing device.

Further, in some embodiments, the multi-image electronic projector 100 may include an audio output device 110 configured to provide audio-based output associated with the at least one media file. Further, the audio output device 110 may be disposed on the top surface of the first portion.

Further, in some embodiments, the multi-image electronic projector 100 may include a storage device configured for storing the at least one media file.

Further, in some embodiments, the power source may include a rechargeable power source.

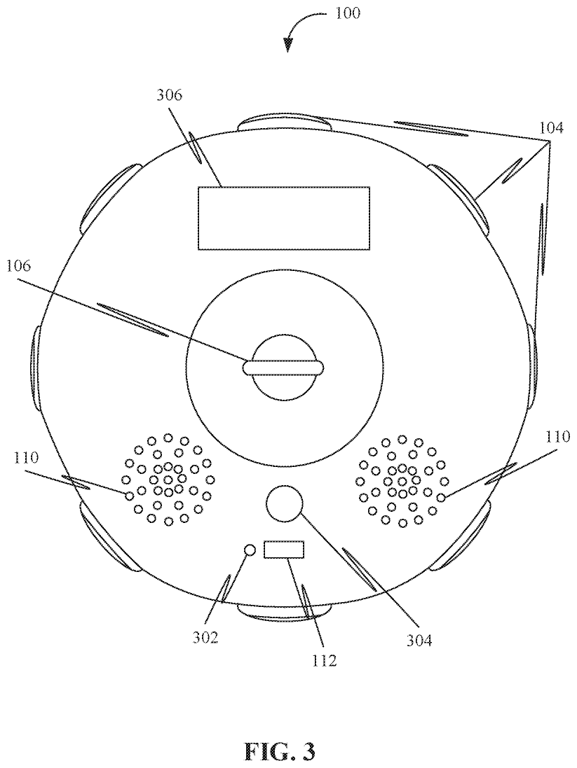

Further, in some embodiments, the multi-image electronic projector 100 may include at least one charging port 302 configured to receive a charging cable for recharging the rechargeable power source, as shown in FIG. 3.

Further, in some embodiments, the at least one media file may include at least one of an image, and a video.

Further, in some embodiments, the multi-image electronic projector 100 may be configured for projecting a plurality of media files simultaneously from the plurality of projection lenses 104.

Further, in some embodiments, the multi-image electronic projector 100 may include at least one connection port 112 configured for facilitating a wired connection of a user device to the multi-image electronic projector 100 for receiving the at least one media file.

Further, in some embodiments, the input mechanism 108 may include a touch display 306 configured for receiving user input through one or more touch gestures, as shown in FIG. 3. Further, the input mechanism 108 may include a power button configured to control the operation state of the multi-image electronic projector 100 by manipulation of an electrical switch 304 electrically coupled with the power source, as shown in FIG. 3.

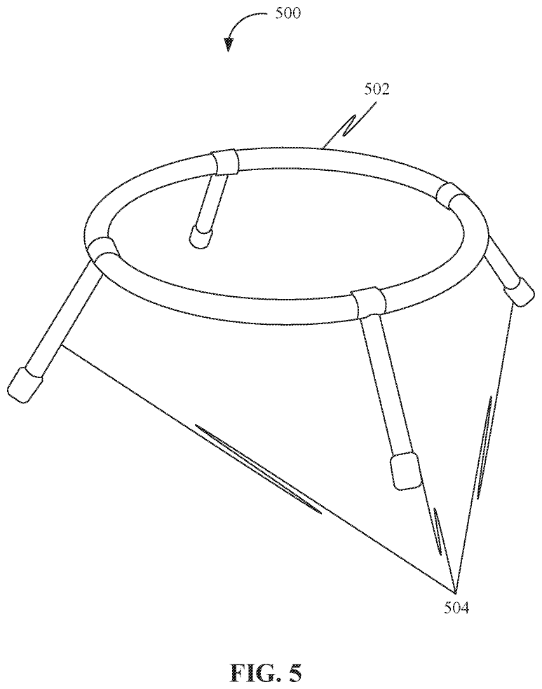

Further, in some embodiments, the multi-image electronic projector 100 may include a ring shaped stand 500. Further, the ring shaped stand 500 may include a plurality of legs 504 configured to support a circular supporting structure 502, as shown in FIG. 5. Further, the circular supporting structure 502 may be configured for supporting the main body 102.

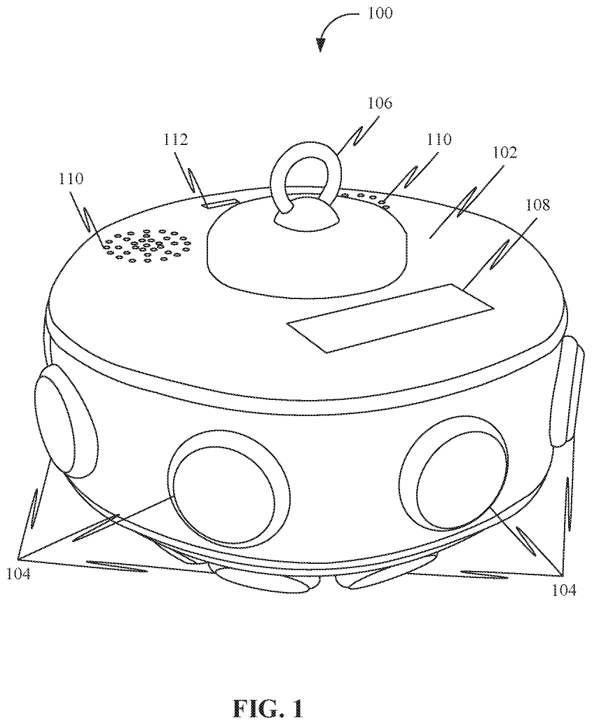

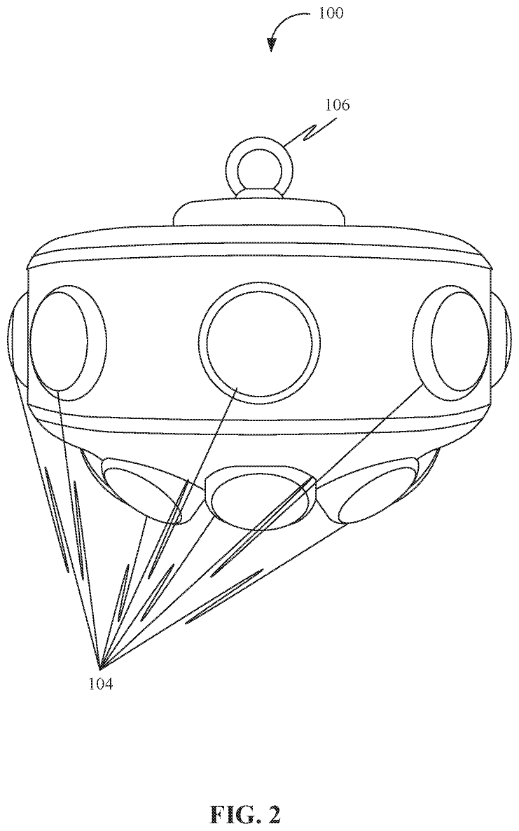

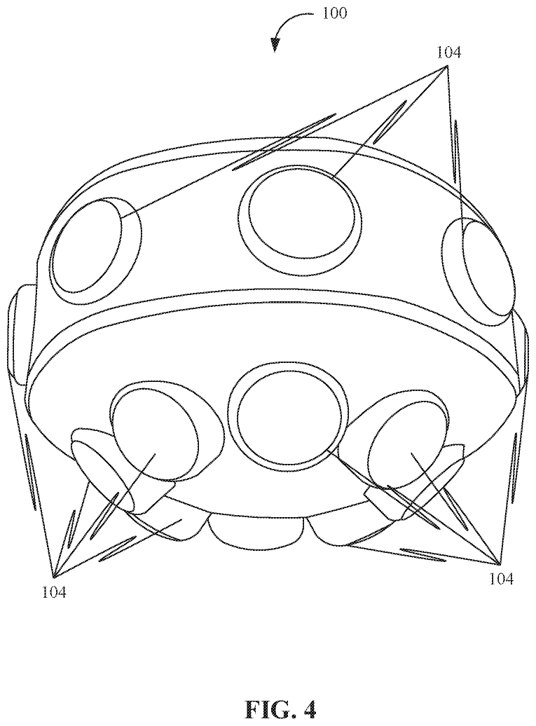

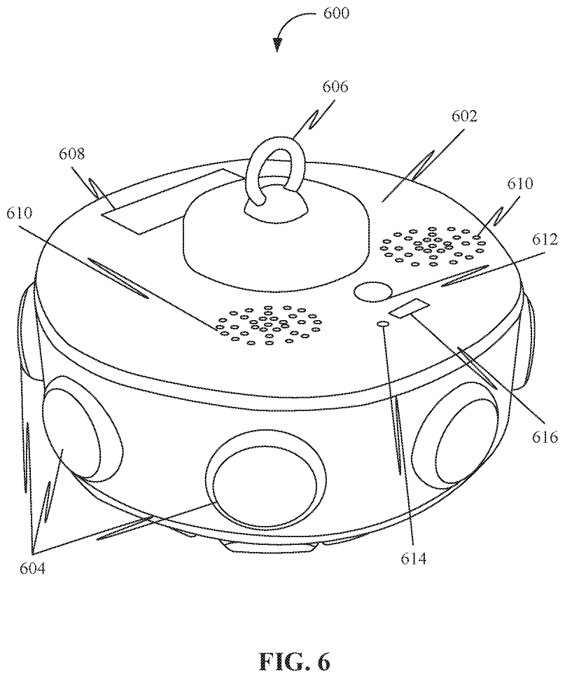

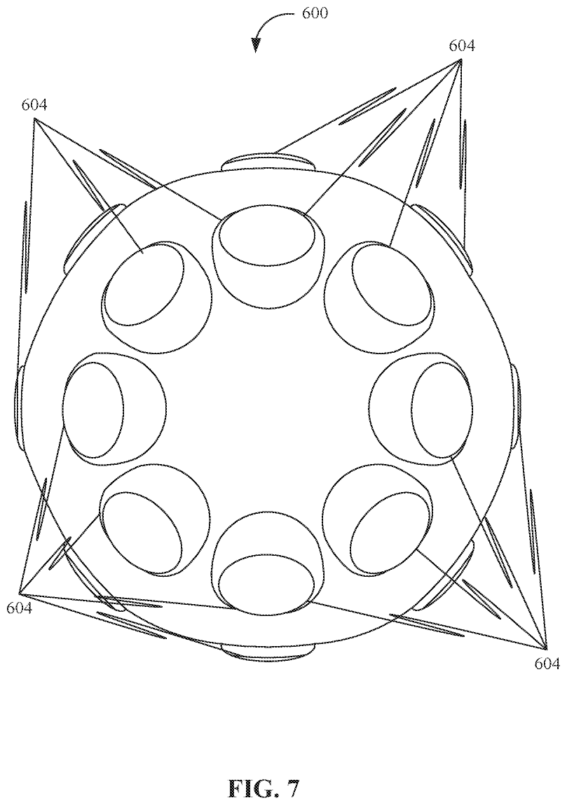

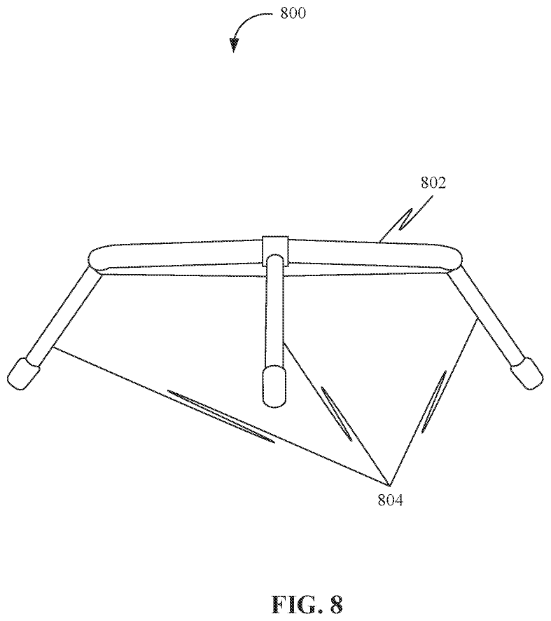

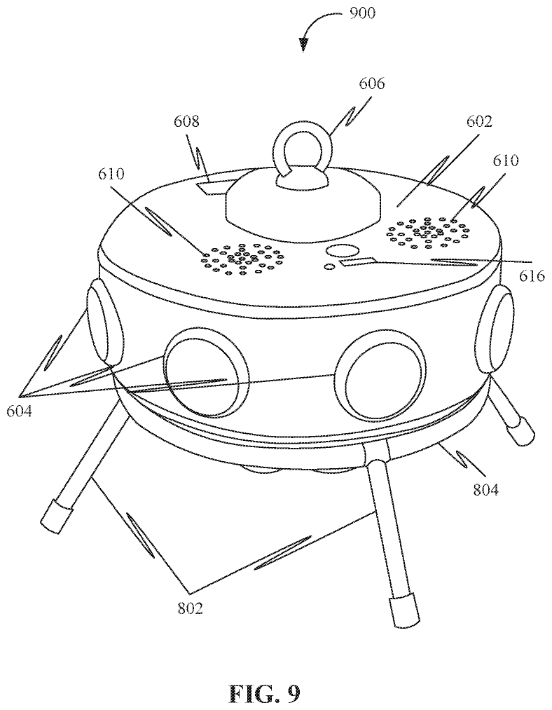

Further, FIG. 1 is a front perspective view of a multi-image projector, in accordance with some embodiments. Further, FIG. 2 is a front view of the multi-image projector. Further, FIG. 3 is a top view of the multi-image projector. Further, FIG. 4 is a bottom perspective view of the multi-image projector. Further, FIG. 5 is a side view of a ring shaped stand, in accordance with some embodiments. Further, FIG. 6 is a rear perspective view of the multi-image projector. Further, FIG. 7 is a bottom view of the multi-image projector. Further, FIG. 8 is a top perspective view of the ring shaped stand. Further, FIG. 9 is a front perspective view of the multi-image projector mounted on the ring shaped stand.

A multi-image electronic projector 600 configured for projecting multiple images may be disclosed. Further, the multi-image electronic projector 600 may include a main body 602, a ring 606, a plurality of projection lenses 604, a touch display 608, a communication device, a processing device, a power source, an audio output device 610 and a ring shaped stand 800.

Further, the main body 602 may include a generally elongated shape. Further, the main body 602 may include a generally cylindrical first portion, and a generally hemispherical second portion extending downwards from a bottom end of the first portion.

Further, the ring 606 may be extending from a top surface of the first portion. Further, the ring 606 may be configured to suspend the multi-image electronic projector 600 from a suspension mechanism.

Further, the plurality of projection lenses 604 disposed on each of the first portion and the second portion configured for projecting at least one media file.

Further, the touch display 608 may be configured for receiving user input through one or more touch gestures corresponding to at least one of an operation mode and an operation state of the multi-image electronic projector 600.

Further, the communication device may be configured for receiving the at least one media file from a user device

Further, the processing device may be communicatively connected to the communication device configured for projecting the at least one media file through the plurality of projection lenses 604.

Further, the power source electrically coupled to each of the communication device, the plurality of projection lenses 604, the input mechanism, and the processing device.

Further, the audio output device 610 may be disposed on the top surface of the first portion configured to provide audio-based output included in the at least one media file.

Further, the ring shaped stand 800 may include a plurality of legs 804 configured to support a circular supporting structure 802. Further, the circular supporting structure 802 may be configured for supporting the main body 602 as shown in FIG. 9.

Further, in some embodiments, the multi-image electronic projector 600 may include a storage device configured for storing the at least one media file.

Further, in some embodiments, the power source may include a rechargeable power source.

Further, in some embodiments, the multi-image electronic projector 600 may include at least one charging port 614 configured to receive a charging cable for recharging the rechargeable power source.

Further, in some embodiments, the at least one media file may include at least one of an image, and a video.

Further, in some embodiments, the multi-image electronic projector 600 may be configured for projecting a plurality of media files simultaneously from the plurality of projection lenses 604.

Further, in some embodiments, the multi-image electronic projector 600 may include at least one connection port 616 configured for facilitating a wired connection of a user device to the multi-image electronic projector 600 for receiving the at least one media file.

Further, in some embodiments, the input mechanism may include a power button 612 configured to control the operation state of the multi-image electronic projector 600 by manipulation of an electrical switch coupled with the power source.

Further, according to some embodiments, a projector, such as the multi-image electronic projector may be disclosed. Further, the projector may be roughly hemispheric in shape. A top surface of the projector may be flat and circular, including a ring, such as the ring 106 at a center. The projector may be suspended from a cord or ribbon which may be tied to or passed through the ring, and may be intended for suspension at the center of a room. Further, front, side, and rear surfaces of the projector may form a cylinder below the top surface. Further, a plurality of projection lenses, such as the plurality of projection lenses 104, preferably eight projection lenses, may be distributed at equal intervals around the perimeter of the cylinder, facing outward. Further, the plurality of projection lenses, preferably eight projection lenses, may be distributed at equal intervals on the bottom surface, facing downward at a 45° angle.

Further, the top surface further may include a touchscreen, such as the touch display 306, two speakers, such as the audio output device 110, an on/off button, such as the power button 612, a charging port, such as the at least one charging port 614, and a Universal Service Bus (USB) port, such as the at least one connection port 616. Further, the projector may include electronic components, such as a microprocessor, a memory device, and a high-capacity rechargeable battery. Further, a mobile application may be installed on the memory device, which may be used to control the projector by operating the touchscreen. The touchscreen further may include a power bar symbol, indicating the amount of power remaining in the battery.

Digital audio and video files may be transferred from other devices, such as a smartphone, a digital audio player, or a digital camera, to the memory device of the projector by using the USB port. A detachable recharging cord, capable of being plugged into any standard wall outlet, may be plugged into the charging port to recharge the battery. Audio files may be played using the speakers, and the projector may be activated or deactivated using the on/off button

Further, the projector may include a ring-shaped stand, such as the ring shaped stand 800 which may include a small plurality of at least three legs, such as the plurality of legs 804. The stand may be placed on the floor or a table at the center of a room, and the projector may then be placed on the stand. This may include an alternative to suspending the projector from the ceiling, but prevents the projection lenses on the bottom surface of the projector from being used effectively.

To use the projector, a user may operate the touchscreen, using the mobile application to select images from the memory device, a projection pattern using one or more manually selected projection lenses, and one or more audio files from the memory device to assemble a multimedia presentation for an event, such as a party or family reunion.

The projector, the projection lenses, the ring, the speakers, the on/off button, the charging port, the USB port, the memory device, and the microprocessor may be manufactured from rigid, durable materials, such as steel, aluminum alloy, brass, plastic, copper alloy, and ceramics. The touchscreen may be preferably manufactured from a rigid, durable material which may be transparent, such as methacrylate or plastic.

Components, component sizes, and materials listed above are preferable, but artisans will recognize that alternate components and materials could be selected without altering the scope of the disclosure.

While the foregoing written description of the disclosure enables one of ordinary skill to make and use what may be presently considered to be the best mode thereof, those of ordinary skill in the art will understand and appreciate the existence of variations, combinations, and equivalents of the specific embodiment, method, and examples herein. The disclosure should, therefore, not be limited by the above described embodiment, method, and examples, but by all embodiments and methods within the scope and spirit of the disclosure.

Although the disclosure has been explained in relation to its preferred embodiment, it is to be understood that many other possible modifications and variations can be made without departing from the spirit and scope of the disclosure.

What is claimed is:

1. A multi-image electronic projector comprising:
a main body comprising a generally elongated shape, wherein the main body comprises a generally cylindrical first portion, and a generally hemispherical second portion extending downwards from a bottom end of the first portion;
a ring extending from a top surface of the first portion, wherein the ring is configured to suspend the multi-image electronic projector from a suspension mechanism;
a plurality of projection lenses disposed on each of the first portion and the second portion configured for projecting at least one media file;
at least one input mechanism configured to receive user input corresponding to at least one of an operation mode and an operation state of the multi-image electronic projector;
a communication device configured for receiving the at least one media file from a user device;
a processing device communicatively connected to the communication device configured for projecting the at least one media file through the plurality of projection lenses; and
a power source electrically coupled to each of the communication device, the plurality of projection lenses, the input mechanism, and the processing device.

2. The multi-image electronic projector of claim 1 further comprising an audio output device configured to provide audio-based output associated with the at least one media file.

3. The multi-image electronic projector of claim 2, wherein the audio output device is disposed on the top surface of the first portion.

4. The multi-image electronic projector of claim 1 further comprising a storage device configured for storing the at least one media file.

5. The multi-image electronic projector of claim 1, wherein the power source comprises a rechargeable power source.

6. The multi-image electronic projector of claim 5 further comprising at least one charging port configured to receive a charging cable for recharging the rechargeable power source.

7. The multi-image electronic projector of claim 1, wherein the at least one media file comprises at least one of an image, and a video.

8. The multi-image electronic projector of claim 1 further configured for projecting a plurality of media files simultaneously from the plurality of projection lenses.

9. The multi-image electronic projector of claim 1 further comprising at least one connection port configured for facilitating a wired connection of a user device to the multi-image electronic projector for receiving the at least one media file.

10. The multi-image electronic projector of claim 1, wherein the input mechanism comprises a touch display configured for receiving user input through one or more touch gestures.

11. The multi-image electronic projector of claim 1, wherein the input mechanism comprises a power button configured to control the operation state of the multi-image electronic projector by manipulation of an electrical switch electrically coupled with the power source.

12. The multi-image electronic projector of claim 1 further comprising a ring shaped stand, wherein the ring shaped stand comprises a plurality of legs configured to support a circular supporting structure, wherein the circular supporting structure is configured for supporting the main body.

13. A multi-image electronic projector comprising:
a main body comprising a generally elongated shape, wherein the main body comprises a generally cylindrical first portion, and a generally hemispherical second portion extending downwards from a bottom end of the first portion;
a ring extending from a top surface of the first portion, wherein the ring is configured to suspend the multi-image electronic projector from a suspension mechanism;
a plurality of projection lenses disposed on each of the first portion and the second portion configured for projecting at least one media file;
a touch display configured for receiving user input through one or more touch gestures corresponding to at least one of an operation mode and an operation state of the multi-image electronic projector;
a communication device configured for receiving the at least one media file from a user device;
a processing device communicatively connected to the communication device configured for projecting the at least one media file through the plurality of projection lenses; and
a power source electrically coupled to each of the communication device, the plurality of projection lenses, the input mechanism, and the processing device;
an audio output device disposed on the top surface of the first portion configured to provide audio-based output included in the at least one media file; and
a ring shaped stand, wherein the ring shaped stand comprises a plurality of legs configured to support a circular supporting structure, wherein the circular supporting structure is configured for supporting the main body.

14. The multi-image electronic projector of claim 14 further comprising a storage device configured for storing the at least one media file.

15. The multi-image electronic projector of claim 14, wherein the power source comprises a rechargeable power source.

16. The multi-image electronic projector of claim 15 further comprising at least one charging port configured to receive a charging cable for recharging the rechargeable power source.

17. The multi-image electronic projector of claim 14, wherein the at least one media file comprises at least one of an image, and a video.

18. The multi-image electronic projector of claim 14 further configured for projecting a plurality of media files simultaneously from the plurality of projection lenses.

19. The multi-image electronic projector of claim 14 further comprising at least one connection port configured for facilitating a wired connection of a user device to the multi-image electronic projector for receiving the at least one media file.

20. The multi-image electronic projector of claim 14, wherein the input mechanism comprises a power button configured to control the operation state of the multi-image electronic projector by manipulation of an electrical switch coupled with the power source.
